(19) United States
(12) Patent Application Publication
(10) Pub. No.: US 2026/0266563 A1
(43) Pub. Date: Sep. 10, 2026

(54) HIGH TEMPERATURE HEAT PUMPS

(71) Applicant: TerraPower, LLC, Bellevue, WA (US)

(72) Inventor: Jon D McWhirter, Kirkland, WA (US)

(21) Appl. No.: 19/559,899

(22) Filed: Mar. 6, 2026

Related U.S. Application Data
(60) Provisional application No. 63/768,151, filed on Mar. 6, 2025.

(51) Int. Cl. F28D 21/00; G21C 1/02; G21C 15/28

(52) U.S. Cl. CPC F28D 21/001; G21C 1/028; G21C 15/28; F28D 2021/0054

(57) ABSTRACT

A high-temperature heat pump system is designed to efficiently generate industrial heat in the range of 650° C. to 900° C. using phase change materials such as sulfur and/or potassium. The system provides high quality isothermal heat delivery. The heat pump processes include vapor compression and expansion cycles with sulfur and potassium, leveraging their phase change properties for higher coefficients of performance. The sulfur cycle can elevate heat from a sodium-cooled fast reactor to 650° C., while a different type of nuclear reactor can support the potassium cycle, achieving 900° C. This integrated approach enhances energy utilization efficiency by converting reactor heat into valuable high-temperature and high-quality, thermal energy, while the utilization of series cycles further optimizes performance. A potassium cycle can be coupled with a sulfur cycle in series to achieve high quality heat with an excellent coefficient of performance.

### BACKGROUND

Current methods of generating industrial heat within the temperature range of 600° C. to 900° C. predominantly involve the combustion of fossil fuels, including coal, natural gas, and oil. These methods are utilized in numerous industrial applications due to their ability to produce and sustain the high temperatures necessary for processing. Combustion systems typically include boilers and furnaces, which convert the chemical energy stored in these fuels into thermal energy, providing the necessary heat for industrial processes. Despite their effectiveness, these systems contribute significantly to greenhouse gas emissions and dependence on non-renewable resources.

Another method employed in generating industrial heat at these temperatures involves the use of electric arc furnaces and electric resistance heating elements. While these technologies offer precise control over temperature and can convert electrical energy into heat, they are economically viable only where electricity costs are manageable. The need for substantial electrical energy input also limits their environmental sustainability, particularly when the electricity is sourced from non-renewable means.

Many industrial processes require heat in excess of 500° C. In the steel industry, for example, processes like annealing, tempering, and forging are performed at high temperatures to alter the physical and mechanical properties of metal. The cement industry relies on high-temperature kilns for the calcination process, where raw materials are transformed into clinker, a critical component in cement production. Additionally, in chemical manufacturing, high temperatures are crucial for processes such as pyrolysis and heat-based chemical reactions, which facilitate the decomposition and synthesis of various chemical compounds.

Despite the established use of these methods and the critical need for industrial process heat above 500° C. across various industries, significant challenges persist. There is an ongoing demand for more efficient, sustainable, and environmentally friendly technologies to generate industrial heat, addressing the evolving needs for reduced carbon emissions and improved energy utilization. Moreover, producing high-quality heat has been a challenge.

Current high-temperature nuclear reactors, particularly gas-cooled varieties, are capable of producing temperatures around 900° C. using helium as a coolant. However, the heat delivery by helium is limited due to its rapid cooling upon heat extraction and the inability to maintain isothermal conditions. This results in a lower quality of thermal energy.

There remains a need for improved high-temperature heat systems that can replace traditional fossil fuel use in generating industrial heat, particularly in maintaining high-quality thermal energy at elevated temperatures while addressing the limitations present in current technologies.

These, and other, advantages will become apparent to those of skill in the art by reference to the following embodiments and descriptions.

### SUMMARY

According to some embodiments, a heat pump system is coupled to a nuclear reactor, the system including a sulfur cycle heat pump configured to receive heat from the nuclear reactor and elevate a temperature of a sulfur-based working fluid to a first temperature within a range, wherein the sulfur cycle heat pump includes: a sulfur vapor generator for converting sulfur into a vapor state, a compressor coupled to the sulfur vapor generator to compress the sulfur vapor into a higher pressure saturated vapor state, a condenser to condense the compressed sulfur vapor at constant pressure for heat rejection at an isothermal temperature, and an expander to reduce pressure and temperature of the sulfur working fluid, completing the cycle.

The heat pump system may further include a potassium cycle heat pump configured to receive heat delivered by the sulfur cycle heat pump and elevate the temperature of a potassium-based working fluid to a second temperature greater than the first temperature, wherein the potassium cycle heat pump includes a potassium vapor generator to produce potassium vapor, a compressor coupled to the potassium vapor generator to achieve a saturated vapor state, a condenser to condense the compressed potassium vapor for further heat rejection, and an expander to diminish pressure and temperature, thereby completing the potassium cycle.

In some examples, the nuclear reactor is a sodium-cooled fast reactor producing an output temperature between 350° C. and 450° C. In some cases, the first temperature produced by the sulfur cycle heat pump is 650° C.

In some examples, the nuclear reactor is a molten chloride reactor producing output at approximately 650° C. In some cases, the second temperature produced by the potassium cycle heat pump is 900° C.

A sulfur cycle heat pump and a potassium cycle heat pump may be coupled together in series. In this way, the sulfur heat pump receives incoming thermal energy at a first temperature, increases it to a second temperature, which is delivered to the potassium heat pump, which increases the thermal energy to a third temperature.

In some examples, a combined coefficient of performance of the sulfur and potassium cycle heat pumps is configured to enhance energy utilization by converting at least 55% of total reactor heat into high-temperature thermal energy.

A secondary coolant may be coupled to the condenser to facilitate heat transfer to an industrial process.

In some examples, the sulfur cycle is configured to operate in isolation, while in other cases, may be used in combination with a potassium cycle, based on a thermal output for specific industrial applications.

According to some embodiments, a method of producing isothermal industrial process heat using a heat pump system coupled to a nuclear reactor, the method including the steps of extracting heat from the nuclear reactor using a sulfur vapor generator to convert sulfur into a vaporized state; compressing the sulfur vapor to achieve a higher pressure saturated vapor; condensing the compressed sulfur vapor at an isothermal temperature to reject heat; expanding the sulfur working fluid to decrease pressure and temperature; and transferring heat from the sulfur condenser to an industrial process.

The method may further include the step of utilizing the heat rejected by the sulfur condenser to vaporize potassium; compressing the potassium vapor to achieve a saturated vapor state at a higher pressure; condensing the compressed potassium vapor to reject additional heat; and expanding the potassium working fluid to finalize a potassium cycle.

In some examples, the nuclear reactor is a sodium-cooled fast reactor and produces an initial heat output at a temperature between 350° C. and 450° C. In examples, the sulfur vapor generator elevates the sulfur working fluid to reach 650° C. for industrial heat applications.

In some examples, the nuclear reactor is a molten chloride reactor and produces a heat output at approximately 650° C. In examples, a potassium vapor generator elevates the potassium working fluid to reach 900° C. for industrial heat applications.

In some cases, the sulfur and potassium cycles are performed in series to provide high temperature and high-quality heat. For example, the sulfur and potassium cycles may be performed in series to convert at least 55% of heat output of the nuclear reactor into high-temperature thermal energy, such as for industrial use.

In some cases, a secondary coolant is used to facilitate the transfer of heat from the sulfur condenser to the industrial process.

The method may include a sulfur heat pump or in combination with a potassium heat pump depending on a desired temperature and industrial application requirements.

### BRIEF DESCRIPTION OF THE DRAWINGS

The accompanying disclosure and drawings are part of the disclosure and are incorporated into the present specification. The drawings illustrate examples of embodiments of the disclosure and, in conjunction with the description, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like, but not necessarily the same or identical, elements throughout.

Together with the following description, the drawings demonstrate and explain various principles of the present disclosure. Identical descriptions indicate similar, but not necessarily identical, elements. While the exemplary embodiments shown and described herein are susceptible to various modifications and alternative forms, specific embodiments have been shown by way of example in the Drawings and will be described in detail herein, of which:

FIG. 1 illustrates various industrial heating applications and required temperatures;

FIGS. 2A and 2B illustrate an idealized Carnot heat engine cycle PV diagram and T-S diagram respectively;

FIG. 3 illustrates phase diagram (T-P) of sulfur, shown in units of atm and ° C.;

FIG. 4 illustrates, in block diagram form, a heat pump using sulfur as a working fluid, in accordance with some embodiments;

FIG. 5 illustrates a block diagram of a heat pump using potassium as a working fluid, in accordance with some embodiments;

FIG. 6 illustrates thermodynamic basics of a high temperature heat pump coupled to a heat source, in accordance with some embodiments;

FIG. 7 illustrates a block diagram of a first heat pump thermally coupled to a second heat pump, in accordance with some embodiments.

### DETAILED DESCRIPTION OF EMBODIMENTS

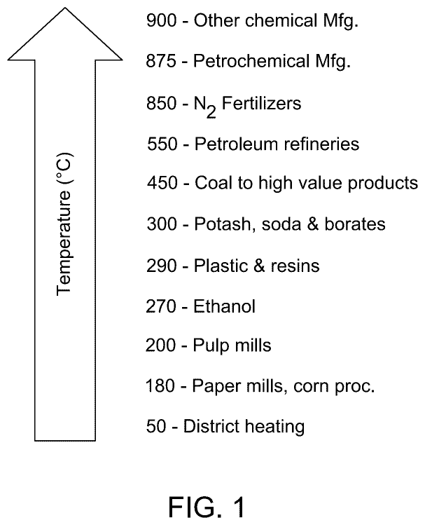

With reference to FIG. 1, various industrial heat applications are depicted with the required industrial temperatures. As illustrated, there are several low temperature heat requirements, from district heat up to forming potash, soda, and borates at about 300° C. This heating is readily available through typical heating sources; however, above 300° C., high quality heat is more difficult to come by without contributing to the negative environmental impacts discussed above. As used herein, “high-quality heat” or “HQ heat” refers to thermal energy that is delivered at a constant, isothermal temperature and possesses a high potential for doing work due to its elevated temperature relative to ambient conditions. Unlike heat that varies widely in temperature or rapidly decreases in intensity, high-quality heat maintains its temperature stability, facilitating efficient energy transfer and utilization. This makes it particularly valuable in industrial processes where precise temperature control is necessary. High-quality heat often involves latent heat transfer, such as during phase changes in materials, which allows for significant energy exchange without large temperature fluctuations.

Most nuclear reactors in operation today operate at temperatures in the lower half of the figure, that is, less than about 300° C. These nuclear reactors would be capable of producing thermal energy at a temperature of up to about 300° C., which is suitable for many lower temperature thermal applications, including power generation.

However, for the higher temperature thermal application (e.g., above 300° C.), traditional water-cooled nuclear power plants are not capable of producing temperatures in this range. However, there are nuclear reactors that are designed to operate at about 350° C.-450° C. that are suitable for providing thermal energy up to their operating temperatures. Other nuclear reactors are designed to be capable of operating at 650° C.-800° C. and could provide heat in this range suitable for the higher temperature industrial uses. However, there are instances where a lower temperature nuclear reactor may be utilized to deliver higher temperature, high-quality heat through an efficient Carnot cycle, as described below.

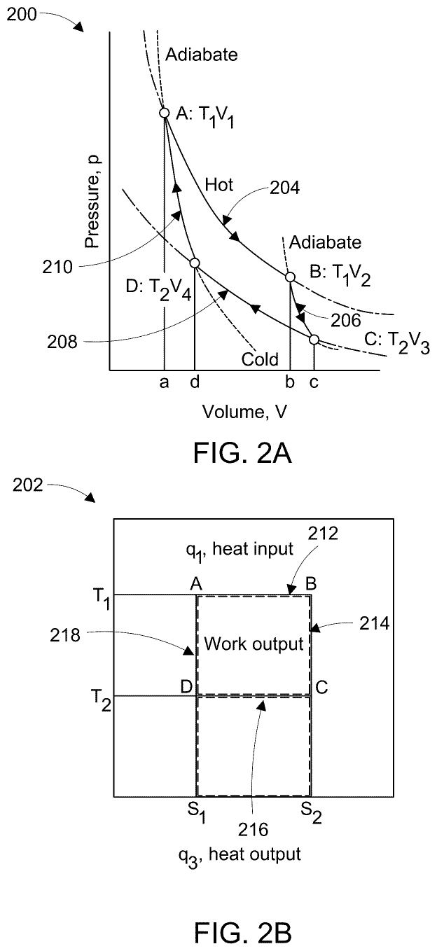

FIGS. 2A and 2B illustrate P-V 200 and T-S 202 diagrams, respectively of an idealized Carnot heat engine cycle. The Carnot cycle is a theoretical thermodynamic cycle that serves as an idealized model for the operation of heat engines. The Carnot cycle consists of four reversible processes:

Isothermal Expansion 204: The working fluid is in contact with a high-temperature reservoir, and heat is absorbed isothermally at a constant temperature TH.

During this process, the gas expands reversibly and performs work on the surroundings. The expansion is typically carried out in a piston-cylinder arrangement.

Adiabatic Expansion 206: After absorbing heat isothermally, the working fluid undergoes adiabatic expansion, during which no heat is exchanged with the surroundings (Q=0). As the gas expands without heat input, its temperature and pressure decrease. This process is reversible and typically involves the rapid expansion of the gas against a piston without heat exchange.

Isothermal Compression 208: The working fluid is in contact with a low-temperature reservoir, and heat is rejected isothermally at a constant temperature Tc. During this process, the gas is compressed reversibly, and work is done on the gas by the surroundings. The compression may be carried out in a piston-cylinder arrangement.

Adiabatic Compression 210: Following isothermal compression, the working fluid undergoes adiabatic compression, during which no heat is exchanged with the surroundings (Q=0). The gas is compressed further without heat exchange, leading to an increase in temperature and pressure. This process is reversible and typically involves the rapid compression of the gas against a piston without heat exchange.

The Carnot cycle T-S diagram illustrates the circular process of temperature versus specific entropy during a thermodynamic process. From the points A to B 212, heat input equals the area of square ABS₁S₂. From B to C 214, transferred heat energy (q)=0. From C to D 216, heat output equals the area of square CS₂S₁D. Finally, from D to A 218, q=0.

The Carnot cycle is characterized by its maximum theoretical efficiency, which is achieved when operating between two temperature reservoirs. The efficiency, n, of the Carnot cycle is given by the equation:

$${η}_{CARNOT} = 1 - \frac{{T}_{L}}{{T}_{H}}$$

Where T_{L} is the absolute temperature of the cold reservoir and TH is the absolute temperature of the hot reservoir. Therefore, larger differences between T_{L} and TH result in higher efficiencies. The Carnot cycle serves as an ideal benchmark for real-world heat engines, highlighting the fundamental limitations imposed by the laws of thermodynamics. Despite its theoretical nature, the Carnot cycle provides valuable insights into the maximum achievable efficiency for practical heat engine systems.

Through mathematical analysis, it has been shown that the Carnot cycle heat engine coupled to a Carnot refrigerator cycle allows for the low temperature reservoir to be lower than the ambient or ultimate heat sink, and the combined efficiency, especially as the ambient temperature increases, does not exceed the efficiency of the ‘bare’ Carnot heat engine. This shows that rejecting heat engine cycle low temperature heat to temperatures below ambient does not violate the 2^{nd} law of thermodynamics.

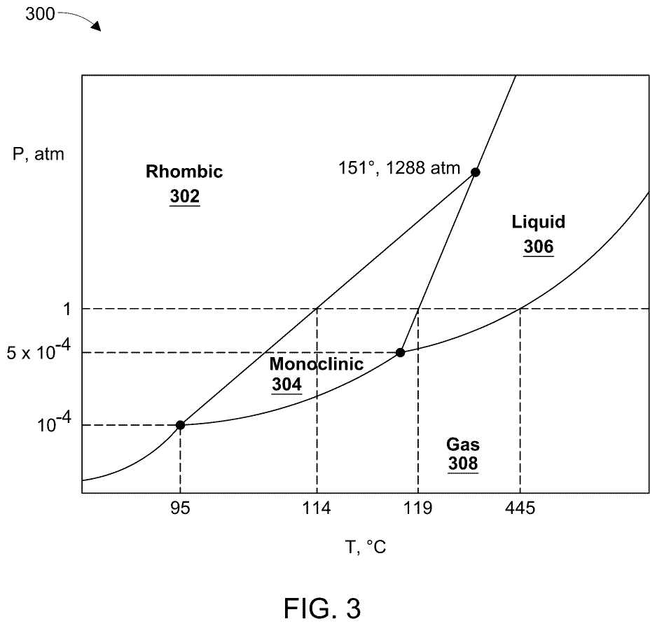

FIG. 3 illustrates a phase diagram 300 of sulfur. The phase diagram 300 of sulfur is a representation of the equilibrium states of sulfur as a function of temperature and pressure. The phase diagram typically illustrates thermophysical properties of sulfur and delineates several key regions and points:

Solid phase: The rhombic phase 302 and monoclinic 304 phase show the solid phase of sulfur. Rhombic sulfur (or α-sulfur) is the most stable phase at room temperature and atmospheric pressure. It exists below 96.6° C. and the crystal structure is an orthorhombic crystal system. The monoclinic sulfur (β-sulfur) stably exists between 95.6° C. and 119° C. at 1 atm. It forms needle-like monoclinic crystals and transforms back into rhombic sulfur when its temperature falls below 95.6° C.

Liquid phase 306: Sulfur melts to a liquid above 119° C. at atmospheric pressure. Initially, liquid sulfur consists of S₈ rings, but as temperature increases, those rings break apart and form long chains, and the viscosity increases by 3 orders of magnitude.

Vapor phase 308 (sulfur gas). Sulfur boils at above 445° C. at atmospheric pressure, and transitions to a vapor phase consisting of various allotropes. At very high temperatures, S₂ becomes the dominant allotrope.

The phase change of sulfur allows it to be a particularly useful working fluid when coupled to a heat source that produces thermal energy at about 350° C. to 450° C., such as a sodium-cooled fast reactor (SFR).

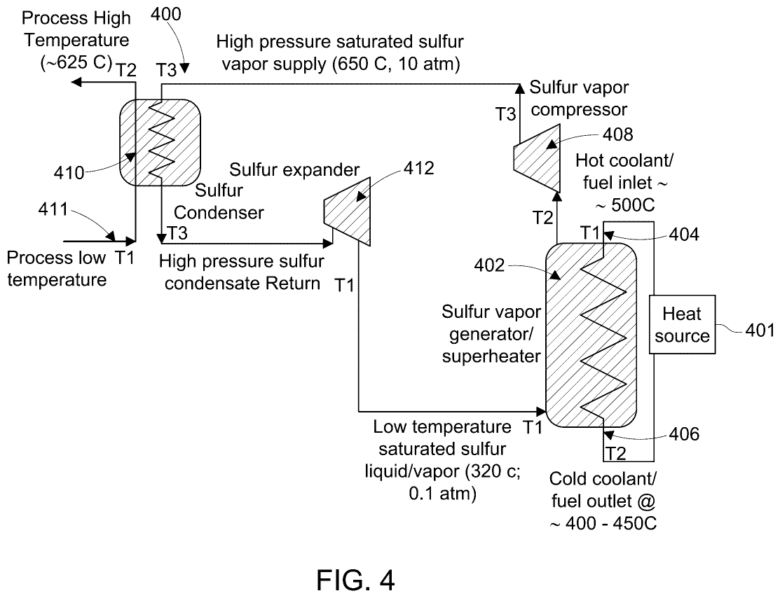

FIG. 4 illustrates a sulfur heat pump 400. A sulfur vapor generator/superheater 402 receives a first working fluid from a heat source 401. The first working fluid is a hot coolant that is delivered at hot coolant/fuel inlet 404 and transfers heat to the sulfur passing therethrough, and exhausts a cold coolant at cold coolant/fuel outlet 406. In some cases, the first working fluid hot coolant comes in at about 500° C. and leaves at a temperature of about 400° C. to 450° C. having transferred thermal energy to the sulfur. The system is agnostic as to the first working fluid, which may be a molten salt, sodium, carbon dioxide (CO₂), helium, hydrogen, sodium-potassium alloys (NaK), lead-bismuth eutectic (LBE), among other suitable working fluids.

It should be appreciated the heat source 401 can be any suitable heat source, and may include, without limitation, geothermal heat, solar heat, fossil fuel combustion, gas combustion, fuel/air combustion, nuclear fission, nuclear fusion, electrical resistance heaters, or any other suitable heat source.

As it passes through the sulfur vapor generators/superheater 402, which may be any suitable heat exchanger, the sulfur boils and phase changes into a vapor. The sulfur vapor generator/superheater 402, along with any of the other heat exchangers used throughout the described embodiments, may be a shell and tube heat exchanger, a plate heat exchanger, a compact heat exchanger, a finned tube heat exchanger, or other suitable type of heat exchanger. As sulfur heats up, the 8-atom ring molecule of sulfur breaks apart and forms long molecular chains, and its viscosity jumps by 3 orders of magnitude. As the sulfur increases in temperature, it becomes unpolymerized, and it becomes pumpable. As the dry sulfur vapor exits the sulfur vapor generator/superheater 402, it is compressed at the sulfur vapor compressor 408. As the sulfur vapor is compressed, its pressure increases and (e.g., 10 atm), it comes to a saturated vapor state.

From this high-pressure saturated vapor state, it enters the sulfur condenser 410. The sulfur may be condensed at a constant pressure, which provides a constant temperature heat rejection, and the sulfur changes phase into a high-pressure sulfur condensate. The high-pressure sulfur condensate is allowed to flow to the sulfur expander 412 and the sulfur becomes a wet sulfur liquid/vapor state at a reduced temperature. In some cases, the sulfur expander 412 may be a throttle valve, a pressure machine, an orifice plate, a piston expander, a rotary screw expander, or some other form of expander that allows the sulfur to change state from a high-pressure sulfur condensate to a low temperature saturated sulfur liquid/vapor. In some embodiments, the sulfur expander 412 is coupled to the sulfur vapor compressor 408 and the work done as the high-pressure sulfur expands may be used to drive the sulfur vapor compressor 408.

After exiting the sulfur expander 412, the sulfur is at a low-temperature and low pressure in a saturated sulfur liquid/vapor phase and can be returned to the sulfur vapor generator/superheater 402 to start the cycle again. In some examples, the low temperature and low-pressure saturated sulfur liquid/vapor entering the sulfur vapor generator/superheater 402 may be about 320° C. at a pressure of about 0.1 atm. These values are given as examples only, and it should be apparent that other temperatures and pressures are contemplated and adjustable based on the components and settings of the components within the system.

At the sulfur condenser 410, high pressure saturated sulfur vapor may enter about 640° C. at a pressure of about 10 atm. Again, these are example temperature and pressures, and they may be adjusted as desired. The sulfur condenser 410 includes a heat exchanger for a second working fluid 411 to enter at a relatively low temperature and extract heat from the sulfur, thus isothermally extracting heat from the sulfur and increasing the temperature of the second working fluid 411. The second working fluid 411 may be any suitable working fluid, such as those described previously in relation to the first working fluid. In any event, the second working fluid 411 may be heated to a temperature of about 625° C. and used for one or more industrial processes. In this way, a heat source, such as a nuclear reactor for example, that outputs heat at about 400° C. to 500° C. can provide a first stage heating of a sulfur working fluid in a sulfur cycle. The sulfur then can be compressed and reach a temperature much higher than the heating source can provide, and thus heat a second working fluid to a higher temperature than if the heating source were used alone to heat the second working fluid.

In this way, the heat source 401 (e.g., nuclear reactor) provides a first stage heating to bring the sulfur working fluid to a first intermediate temperature, and the sulfur is then heated by a second stage process, such as compression, to bring the sulfur working fluid to a second temperature, higher than the first intermediate temperature, which can then be used in an industrial process, such as heating a second working fluid to a temperature above the intermediate temperature. The second working fluid may be heated to any desirable temperature and used for any suitable process, such as, for example, oil refinery, steel making, iron smelting, desalination, among others.

According to some embodiments, a sulfur heating cycle can be coupled to a heating source, such as a nuclear reactor. A first working fluid can be heated to a first intermediate temperature by the heating source which transfers thermal energy to the sulfur. The sulfur can then be compressed to a second high temperature, the second high temperature greater than the first intermediate temperature. The sulfur can then pass through a condenser where it transfers thermal energy to a second working fluid. The second working fluid can be heated to a temperature above the intermediate temperature to a higher temperature suitable for industrial processes. Sulfur is a suitable working fluid for several of the described embodiments because: it has a high latent heat of vaporization, which allows for significant energy absorption and release during phase changes. This allows isothermal conditions and efficiently transferring energy at a constant temperature; it has a melting point at about 115° C. and a boiling point of about 445° C. at ambient pressure. These values can be adjusted, as desired, through pressure manipulation to efficiently operate at target temperatures of up to 650° C. or even higher. Sulfur is chemically stable under the conditions expected within the heat pump system, ensuring reliability and longevity as a working fluid without undesirable reactions that could compromise system components. Unlike many other high temperature working fluids, sulfur is relative non-toxic and abundant. Finally, during melting, sulfur transitions from a ring molecule structure into chain-like polymers, making it pumpable in the system. This characteristic can be leveraged to tailor the heat pump cycle's operation parameters effectively.

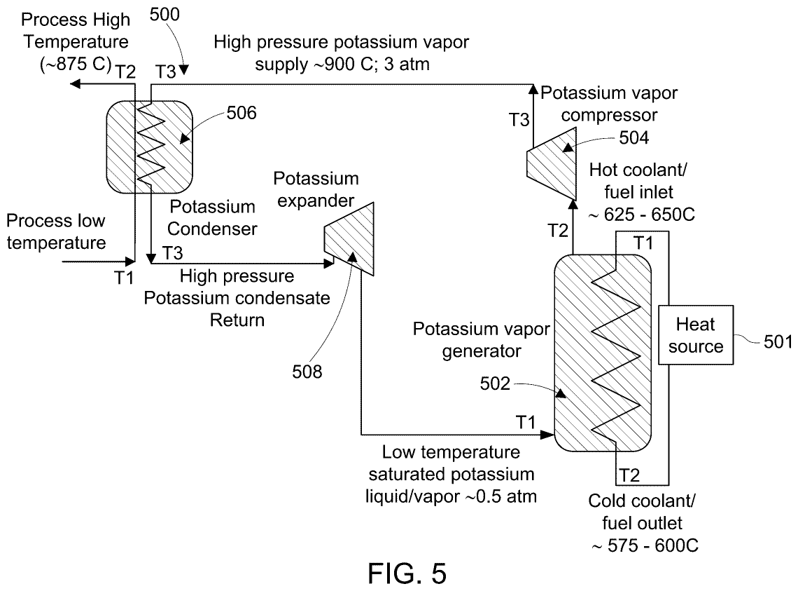

FIG. 5 illustrates a potassium heat pump 500 coupled to a heat source 501. The potassium heat pump 500 is quite similar in nature to the previously described sulfur heat pump, with the exception of the temperatures and pressures involved. For example, the heat source 501, which may be a nuclear reactor, may output thermal energy at about 625° C. to 650° C., which is considerably higher than prior embodiments. Where the heat source is able to produce temperatures in excess of 625° C., a sulfur heat pump may not be ideal. However, a potassium heat pump 500, may be a suitable system to provide industrial heat in excess of 850° C.

A potassium vapor generator 502 receives low temperature (T1) saturated potassium liquid/vapor which may be at a pressure of about 0.5 atm. The potassium vapor generator 502 transfers thermal energy from the heat source to the potassium working fluid to increase its temperature to T2, which is higher than T1. The output of the potassium vapor generator is a wet vapor, which allows compression of the wet vapor while still in the vapor dome to result in saturated vapor at a reasonable temperature. By compressing a wet vapor, that takes the process straight up on the TS diagram for potassium to a saturated vapor state.

The heat source 501 can supply thermal energy to the potassium vapor generator 502 at any suitable temperature, but in some cases is about 625° C. to about 650° C. Any suitable heat source 501 can be coupled to the potassium heat pump 500, and in some cases is a nuclear reactor, such as a molten chloride fast reactor that is designed to operate within this temperature range.

The saturated potassium vapor exits the potassium vapor generator 502 and enters the potassium vapor compressor 504, where it is compressed. Compressing the potassium may increase its temperature to T3, which may be about 900° C., and its pressure to about 3 atm. Of course, the potassium vapor compressor 504 may be tuned to result in other temperatures and pressures, as desired.

The high-pressure potassium vapor coming out of the potassium vapor compressor 504 is sent to the potassium condenser 506, where it exchanges heat isothermally with a second working fluid passing through the potassium condenser 506. The second working fluid may be any suitable working fluid, which may be heated to 800° C. to about 900° C. The actual heating is not important and it is sufficient to note that the second working fluid is heated to a temperature greater than what the heat source 501 is configured to provide. In this way, the potassium heat pump allows a flow of potassium at T1 to be heated by a heat source 501 to a temperature T2, which is higher than T1, and the potassium heat pump then increases the temperature of the potassium to T3, higher than T2. The potassium at temperature T3 can then be used to heat a second working fluid to a temperature above T2 and used for other purposes, such as industrial processes.

After passing through the condenser, high pressure potassium condensate is passed through a potassium expander 508 where it expands and its temperature and pressure are reduced, which may be down to a pressure of about 0.5 atm. The low temperature saturated potassium liquid-vapor can then enter the potassium vapor generator 502 to restart the cycle.

In some cases, the potassium expander 508 may be mechanically coupled to the potassium vapor compressor 504 and work done at the potassium expander 508 may be used to drive, or partially drive, the potassium vapor compressor 504.

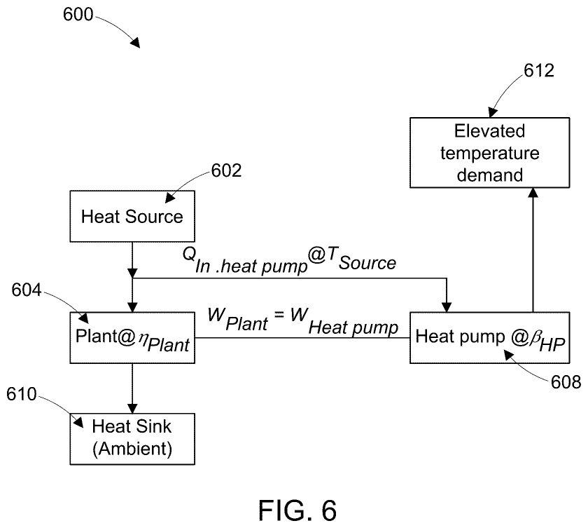

FIG. 6 illustrates a block diagram to help illustrate thermodynamics of a heat pump system 600, in accordance with some embodiments. The heat source 602 may be utilized to provide inlet heat to a thermal energy conversion plant 604 and a portion of heat to a heat pump 606 cycle. In some cases, the plant 604 may receive excess heat, that is, more thermal energy than the heat pump 608 can utilize, in which case, the plant 604 may be in thermal communication with a heat sink 610, which may be another process, an ambient heat removal system, an electricity generation system, or other type of heat sink 610. The plant 604 may be an energy conversion system that converts thermal energy from the heat source 602 into work, such as work necessary to drive the components of the heat pump, such as pumps and/or compressors. The heat pump 608 receives thermal energy from the plant 604 and optionally from the heat source 602, and increases the temperature to provide thermal energy to an elevated temperature demand application, such as an industrial process that requires thermal energy at a temperature above what the plant and/or heat source are able to provide.

Let x≡fraction of SOURCE heat 602 going to the PLANT 604 and (1−x)≡fraction supplied to HEAT PUMP 608.

$${\dot{Q}}_{PLANT} = x \cdot {\dot{Q}}_{SOURCE}$$

$${\dot{Q}}_{IN , HEAT PUMP} = ( 1 - x ) \cdot {\dot{Q}}_{SOURCE}$$

$${η}_{PLANT} ≡ \frac{{\dot{W}}_{PLANT}}{{\dot{Q}}_{PLANT}} \to {\dot{W}}_{PLANT} = {η}_{PLANT} {\dot{Q}}_{PLANT}$$

$$And$$

$${\dot{Q}}_{REJECTED} = {\dot{Q}}_{PLANT} - {\dot{W}}_{PLANT} = {\dot{Q}}_{PLANT} \cdot ( 1 - {η}_{PLANT} )$$

$${β}_{HEAT PUMP} ≡ \frac{{\dot{Q}}_{OUT , HEAT PUMP}}{{\dot{W}}_{HEAT PUP}} \to {\dot{Q}}_{OUT , HEAT PUMP} = {β}_{HEAT PUMP} {\dot{W}}_{HEAT PUMP}$$

$$Also , {\dot{Q}}_{OUT , HEAT PUMP} = {\dot{Q}}_{IN , HEAT PUMP} + {\dot{W}}_{HEAT PUMP}$$

Continuing, since

$${\dot{Q}}_{OUT , HEAT PUMP} = {β}_{HEAT PUMP} \cdot x \cdot {\dot{Q}}_{SOURCE} \cdot {η}_{PLANT}$$

$$And$$

$${\dot{Q}}_{OUT , HEAT PUMP} = ( 1 - x ) \cdot {\dot{Q}}_{SOURCE} + {η}_{PLANT} x \cdot {\dot{Q}}_{SOURCE}$$

We can write

$${β}_{HEAT PUMP} \cdot x \cdot {η}_{PLANT} = ( 1 - x ) + {η}_{PLANT} \cdot x$$

Solving for the unknown, x, in terms of the knowns β_{HEAT PUMP} and η_{PLANT}, We get:

$$x \cdot {β}_{HEAT PUMP} \cdot {η}_{PLANT} = 1 - x ( 1 - {η}_{PLANT} )$$

$$x \cdot {β}_{HEAT PUMP} \cdot {η}_{PLANT} + x ( 1 - {η}_{PLANT} ) = 1$$

$$x ( {β}_{HEAT PUMP} \cdot {η}_{PLANT} + ( 1 - {η}_{PLANT} ) ) = 1$$

$$x = \frac{1}{{β}_{HEAT PUMP} \cdot {η}_{PLANT} + ( 1 - {η}_{PLANT} )}$$

$$∴ x = \frac{1}{1 + {η}_{PLANT} ( {β}_{HEAT PUMP} - 1 )}$$

The fraction of the source heat that can be delivered to the high temperature heat demand 612. R, is:

$$R = \frac{{\dot{Q}}_{OUT , HEAT PUMP}}{{\dot{Q}}_{SOURCE}} = \frac{{β}_{HEAT PUMP} \cdot {η}_{PLANT}}{1 + {η}_{PLANT} ( {β}_{HEAT PUMP} - 1 )}$$

Now for the Carnot Test to show that there's no violation of the 2^{nd} Law of Thermodynamics;

$${β}_{CARNOT} = \frac{{T}_{HIGH , HEAT PUMP}}{{T}_{HIGH , HEAT PUMP} - {T}_{SOURCE}}$$

$$And$$

$${η}_{CARNOT} = \frac{{T}_{SOURCE} - {T}_{AMBIENT}}{{T}_{SOURCE}}$$

Inserting into the expression for the fraction of source heat that can be delivered to the high temperature demand,

$$\begin{matrix}\frac{{\dot{Q}}_{MAX}}{{\dot{Q}}_{SOURCE}} = \frac{{β}_{CARNOT} \cdot {η}_{CARNOT}}{1 + {η}_{CARNOT} ( {β}_{CARNOT} - 1 )} \\ = \frac{\frac{{T}_{HIGH , HEAT PUMP}}{{T}_{HIGH , HEAT PUMP} - {T}_{SOURCE}} \cdot \frac{{T}_{SOURCE} - {T}_{AMBIENT}}{{T}_{SOURCE}}}{1 + \frac{{T}_{SOURCE} - {T}_{AMBIENT}}{{T}_{SOURCE}} [ \frac{{T}_{HIGH , HEAT PUMP}}{{T}_{HIGH , HEAT PUMP} - {T}_{SOURCE}} - 1 ]} \\ = \frac{\frac{{T}_{HIGH , HEAT PUMP}}{{T}_{HIGH , HEAT PUMP} - {T}_{SOURCE}} \cdot \frac{{T}_{SOURCE} - {T}_{AMBIENT}}{{T}_{SOURCE}}}{1 + \frac{{T}_{SOURCE} - {T}_{AMBIENT}}{{T}_{SOURCE}} [ \frac{{T}_{SOURCE}}{{T}_{HIGH , HEAT PUMP} - {T}_{SOURCE}} ]} \\ = \frac{\frac{{T}_{HIGH , HEAT PUMP}}{{T}_{HIGH , HEAT PUMP} - {T}_{SOURCE}} \cdot \frac{{T}_{SOURCE} - {T}_{AMBIENT}}{{T}_{SOURCE}}}{1 + \frac{{T}_{SOURCE} - {T}_{AMBIENT}}{{T}_{HIGH , HEAT PUMP} - {T}_{{SOURCE}_{}}}} \\ = \frac{\frac{{T}_{HIGH , HEAT PUMP}}{{T}_{HIGH , HEAT PUMP} - {T}_{SOURCE}} \cdot \frac{{T}_{SOURCE} - {T}_{AMBIENT}}{{T}_{SOURCE}}}{\frac{{T}_{HIGH , HEAT PUMP} - {T}_{SOURCE}}{{T}_{HIGH , HEAT PUMP} - {T}_{SOURCE}} + \frac{{T}_{SOURCE} - {T}_{AMBIENT}}{{T}_{HIGH , HEAT PUMP} - {T}_{{SOURCE}_{}}}} \\ = \frac{\frac{{T}_{HIGH , HEAT PUMP}}{{T}_{HIGH , HEAT PUMP} - {T}_{SOURCE}} \cdot \frac{{T}_{SOURCE} - {T}_{AMBIENT}}{{T}_{SOURCE}}}{\frac{{T}_{HIGH , HEAT PUMP} - {T}_{AMBIENT}}{{T}_{HIGH , HEAT PUMP} - {T}_{{SOURCE}_{}}}} \\ = \frac{{T}_{HIGH , HEAT PUMP}}{{T}_{SOURCE}} \frac{{T}_{SOURCE} - {T}_{AMBIENT}}{{T}_{HIGH , HEAT PUMP} - {T}_{AMBIENT}} \\ = \frac{\frac{{T}_{SOURCE} - {T}_{AMBIENT}}{{T}_{SOURCE}}}{\frac{{T}_{HIGH , HEAT PUMP} - {T}_{AMBIENT}}{{T}_{HIGH , HEAT PUMP}}} = \frac{1 - \frac{{T}_{AMBIENT}}{{T}_{SOURCE}}}{1 - \frac{{T}_{AMBIENT}}{{T}_{HIGH , HEAT PUMP}}}\end{matrix}$$

Which can be recognized as the ratio of two Carnot cycle efficiencies:one (numerator) for the efficiency based upon the source temperature and another based upon a cycle absorbing heat at the High Heat Pump Source temperature. That is, if we try to generate work from a heat input at the High Heat Pump Source temperature, we get out the work associated with the original heat source temperature. This confirms that the 2nd Law is not violated.

An efficient heat pump will be modeled as a Carnot level, with T_{AMBIENT}=300 K, T_{SOURCE}=800 K (527° C.) and T_{DEMAND}=1200 K (927° C.), β_{HEAT PUMP}=1200/(1200-800)=3, and the plant efficiency η_{PLANT} around 40%, the fraction of the source heat that can be delivered to the High Temperature Heat Demand 612 is:

$$R = \frac{{\dot{Q}}_{OUT , HEAT PUMP}}{{\dot{Q}}_{SOURCE}} = \frac{3 \cdot 0.4}{1 + 0.4 ( 3 - 1 )} = \frac{2}{3}$$

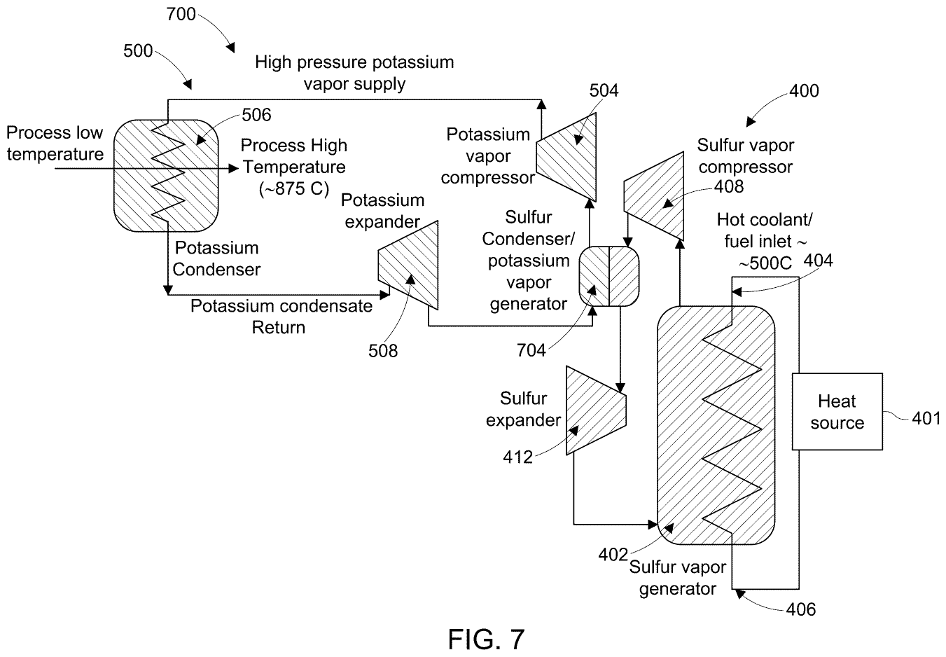

FIG. 7 illustrates an embodiment of cascading heat pumps coupled in series 700. This may be used, for example, with a heat source 401 that provides thermal energy at a temperature of about 500° C., and the first stage sulfur heat pump, raises the temperature to about 650° C., followed by a second stage potassium heat pump, that raises the operating temperature to upwards of 900° C. or higher. In this way, a heat source 401, such as a nuclear reactor, can be used to provide industrial process heat at a temperature of 900° C. or higher by using a multi-stage heat pump system. The heat source provides thermal energy at a first temperature, a first stage heat pump raises the first temperature to a second temperature higher than the first temperature, and a second stage heat pump raises the temperature to a third temperature, higher than the second temperature. As mentioned above, while examples are described by using a sulfur heat pump and a potassium heat pump, it should be appreciated that any suitable working fluid may be used in the embodiments described herein.

In the illustrated example, a heat source provides initial thermal energy to the hot coolant/fuel inlet 404 at about 500° C. The heat source may be a nuclear reactor. The sulfur heat pump cycle 400 operates as substantially described elsewhere herein. The illustrated difference is that the output thermal energy from the sulfur cycle 400 (e.g., the thermal load of the sulfur cycle), rather than being used directly for an industrial process, is transferred to a potassium cycle 500, which then increases the thermal energy to upwards of 900° C. or higher. Accordingly, the sulfur condenser/potassium vapor generator 704, operates at a temperature sufficient to boil potassium.

With a heat source providing thermal energy at about 500° C., the sulfur heat pump 400 can receive all of the thermal energy and convert 55% of it to high temperature heat coming out of the potassium cycle 500. The remaining 45% of the heat source thermal energy can be rejected to ambient, can be used for other processes, such as district heating, or otherwise. This allows all of the thermal energy produced by the heat source to be used for something useful.

The following illustrates thermodynamic calculations for cascading heat pumps coupled in series, as illustrated.

We can derive an expression for effective composite coefficient of performance for the two heat pumps with coefficients of performance β_{ITHP} and β_{HTHP}, i.e.,

$${β}_{COMP} = f ( {β}_{ITHP} , {β}_{HTHP} )$$

So, we start with

$${β}_{COMP} = \frac{{\dot{Q}}_{OUT , HTHP}}{{\dot{W}}_{\dot{ITHP}} + {W}_{HTHP}} = \frac{{\dot{Q}}_{OUT , HTHP}}{\frac{{\dot{Q}}_{OUT , ITHP}}{{β}_{ITHP}} + \frac{{\dot{Q}}_{OUT , ITHP}}{{β}_{HTHP}}} = \frac{{\dot{Q}}_{OUT , HTHP}}{\frac{{\dot{Q}}_{IN , HTHP}}{{β}_{ITHP}} + \frac{{\dot{Q}}_{OUT , ITHP}}{{β}_{HTHP}}} = \frac{1}{\frac{{\dot{Q}}_{IN , HTHP}}{{\dot{Q}}_{OUT , HTHP}} \frac{1}{{β}_{ITHP}} + \frac{1}{{β}_{HTHP}}}$$

It can be shown that

$$\frac{{\dot{Q}}_{IN , HTHP}}{{\dot{Q}}_{OUT , HTHP}} = 1 - \frac{1}{{β}_{HTHP}}$$

$$So {β}_{COMP} = \frac{1}{[ 1 - \frac{1}{{β}_{HTHP}} ] \frac{1}{{β}_{ITHP}} + \frac{1}{{β}_{HTHP}}}$$

Simplifying and rearranging,

$$∴ {β}_{COMP} = \frac{{β}_{ITHP} {β}_{HTHP}}{{β}_{ITHP} + {β}_{HTHP} - 1}$$

If we include sample numbers as an example:

$$For {β}_{ITHP} = {β}_{HTHP} = 3 ,$$

$${β}_{COMP} = \frac{3 \cdot 3}{3 + 3 - 1} = 1.8$$

Now, for a sodium-cooled fast reactor thermal plant,

$$R = \frac{1.8 \cdot 0.4}{1 + 0.4 ( 1.8 - 1 )} = 0.545$$

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only and not used for purposes of limitation.

According to some example embodiments, the systems and/or methods described herein may be under the control of one or more processors. The one or more processors may have access to computer-readable storage media (“CRSM”), which may be any available physical media accessible by the processor(s) to execute instruction stored on the CRSM. In one basic implementation, CRSM may include random access memory (“RAM”) and Flash memory. In other implementations, CRSM may include, but is not limited to, read-only memory (“ROM”), electrically erasable programmable read-only memory (“EEPROM”), or any other medium which can be used to store the desired information, and which can be accessed by the processor(s). For example, the operation of the refrigeration system and the auxiliary cooling system may be controlled by one or more processors.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners.

Unless otherwise noted, the terms “connected to” and “coupled to” (and their derivatives), as used in the specification and/or Appendix, are to be construed as permitting both direct and indirect (i.e., via other elements or components) connection. In addition, the terms “a” or “an,” as used in the specification and/or Appendix, are to be construed as meaning “at least one of.” Finally, for ease of use, the terms “including” and “having” (and their derivatives), as used in the specification and/or Drawings, are interchangeable with and have the same meaning as the word “comprising.”

From the foregoing, and the accompanying Drawings, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A heat pump system coupled to a nuclear reactor, the system comprising:
a nuclear reactor configured to generate heat at a first temperature;
a sulfur cycle heat pump configured to receive heat from the nuclear reactor at the first temperature and elevate a temperature of a sulfur-based working fluid to a second temperature, wherein the sulfur cycle heat pump includes:
a sulfur vapor generator for converting sulfur into a vapor state;
a compressor coupled to the sulfur vapor generator to compress the sulfur vapor into a higher pressure saturated vapor state;
a condenser to condense the compressed sulfur vapor at constant pressure for heat rejection at an isothermal temperature; and
an expander to reduce pressure and temperature of the sulfur working fluid, completing the cycle.

2. The heat pump system of claim 1, further comprising a potassium cycle heat pump, configured to receive heat rejected by the sulfur cycle heat pump at the second temperature and elevate the temperature of a potassium-based working fluid to a third temperature greater than the first temperature, wherein the potassium cycle heat pump includes:
a potassium vapor generator to produce potassium vapor,
a compressor coupled to the potassium vapor generator to achieve a saturated vapor state;
a condenser to condense the compressed potassium vapor for further heat rejection; and
an expander to diminish pressure and temperature, thereby completing the potassium cycle.

3. The heat pump system of claim 2, wherein the nuclear reactor is a sodium-cooled fast reactor producing an output temperature between 350° C. and 450° C.

4. The heat pump system of claim 3, wherein the second temperature produced by the sulfur cycle heat pump is 650° C.

5. The heat pump system of claim 2, wherein the nuclear reactor is a molten chloride reactor producing output at approximately 650° C.

6. The heat pump system of claim 5, wherein the third temperature produced by the potassium cycle heat pump is 900° C.

7. The heat pump system of claim 2, wherein the sulfur cycle heat pump and potassium cycle heat pump are coupled in series.

8. The heat pump system of claim 7, wherein a combined coefficient of performance of the sulfur and potassium cycle heat pumps is configured to enhance energy utilization by converting up to 55% of total reactor heat into high-temperature thermal energy.

9. The heat pump system of claim 1, further comprising a secondary coolant coupled to the condenser to facilitate heat transfer to an industrial process.

10. The heat pump system of claim 1, wherein the sulfur cycle is configured to operate in isolation or in combination with a potassium cycle, based on a thermal output for specific industrial applications.

11. A method of producing isothermal industrial process heat using a heat pump system coupled to a nuclear reactor, the method comprising:
generating heat at a nuclear reactor;
extracting heat from the nuclear reactor using a sulfur vapor generator to convert sulfur into a vaporized state;
compressing the sulfur vapor to achieve a higher pressure saturated vapor;
condensing the compressed sulfur vapor at an isothermal temperature to reject heat;
expanding the sulfur working fluid to decrease pressure and temperature; and
transferring heat from the sulfur condenser to an industrial process.

12. The method of claim 11, further comprising:
utilizing the heat rejected by the sulfur condenser to vaporize potassium;
compressing the potassium vapor to achieve a saturated vapor state at a higher pressure;
condensing the compressed potassium vapor to reject additional heat; and
expanding the potassium working fluid to finalize a potassium cycle.

13. The method of claim 12, wherein the nuclear reactor is a sodium-cooled fast reactor and produces an initial heat output at a temperature between 350° C. and 450° C.

14. The method of claim 13, wherein the sulfur vapor compressor elevates the sulfur working fluid to reach 650° C. for industrial heat applications.

15. The method of claim 12, wherein the nuclear reactor is a molten chloride reactor and produces a heat output at approximately 650° C.

16. The method of claim 15, wherein a potassium vapor compressor elevates the potassium working fluid to reach 900° C. for industrial heat applications.

17. The method of claim 12, wherein the sulfur and potassium cycles are performed in series to improve thermal efficiency.

18. The method of claim 17, wherein the sulfur and potassium cycles performed in series converts up to 55% of heat output of the nuclear reactor into high-temperature thermal energy for industrial use.

19. The method of claim 11, further comprising using a secondary coolant to facilitate the transfer of heat from the sulfur condenser to the industrial process.

20. The method of claim 12, wherein the method utilizes a sulfur heat pump or in combination with a potassium heat pump depending on a desired temperature and industrial application requirements.
